(19) United States
(12) Patent Application Publication
(10) Pub. No.: US 2003/0052587 A1
(43) Pub. Date: Mar. 20, 2003

(54) Color cathode ray tube

(76) Inventors: Masahiro Nishizawa, Mobara (JP); Maki Taniguchi, Ichihara (JP); Noriharu Matsudate, Kujuukuri (JP)

Correspondence Address: Christopher E. Chalsen, Esq., Milbank, Tweed,, Hadley & McCloy LLP, 1 Chase Manhattan Plaza, New York, NY, 10005-1413, US

(21) Appl. No.: 10/218,703

(22) Filed: Aug. 14, 2002

(30) Foreign Application Priority Data
Aug. 28, 2001 (JP) 2001-257874

(51) Int. Cl. H01J 29/80

(52) U.S. Cl. 313/402

(57) ABSTRACT

A large number of micropores are formed in a surface of a metal base body of a shadow mask provided to a color cathode ray tube and a surface film is formed such that the surface film impregnates these micropores and covers the metal base body. Due to such a constitution, it is possible to realize a color cathode ray tube having a press mask of a large radius of curvature which can reduce the thermal deformation such as doming.

### BACKGROUND OF THE INVENTION

1. Field of the Invention

The present invention relates to a shadow mask type color cathode ray tube, and more particularly to a highly reliable color cathode ray tube which can reduce the thermal deformation such as doming while enhancing the rigidity of a shadow mask which constitutes a color selection electrode.

2. Description of the Related Art

With respect to a color cathode ray tube which has been used as a monitor device for a recent information equipment or display means of a color television receiving set, flat facing which flattens a panel (face panel) constituting an image display screen has been rapidly spreading. Particularly, when a press forming type shadow mask (press mask) which makes an apertured surface curved in the horizontal direction as well as in the vertical direction is adopted, a panel of this flat-face color cathode ray tube (flat face tube) has an outer surface which is substantially planer and an inner surface with a curvature considerably larger than that of the outer surface.

As one of technical tasks at the time of designing such a flat face tube, the enhancement of the strength of the shadow mask is named. Although the shadow mask is formed such that a curvature thereof approximates the curvature of the inner surface of the panel, the flat face tube exhibits the smaller panel inner-surface curvature compared to a round face tube whose inner and outer surfaces are curved and hence, the curvature of the shadow mask of the flat face tube must be also small.

Accordingly, it is difficult for the shadow mask to maintain the strength against the partial thermal deformation of an apertured region of the shadow mask or the thermal deformation of the whole shadow mask derived from a so-called doming phenomenon which is caused by the elevation of the temperature of the shadow mask due to the impingement of electron beams in operation. To obviate this thermal deformation also constitutes one of large tasks to be solved. Further, when the curvature of the shadow mask is small (that is, when the radius of curvature is large), it is difficult for the shadow mask to maintain the physical strength against the fall, shock or the like which the shadow mask receives at the time of manufacturing, transporting or using the color cathode ray tube.

As attempts to prevent the color slurring of images caused by the thermal expansion of the shadow mask and to enhance the strength of the shadow mask, following means have been proposed conventionally.

(1) Heavy metal having high electron reflection ability or a compound layer thereof is formed on an electron beam irradiation side (electron gun side) of a base portion of a shadow mask (for example, Japanese Laid-open Patent Publication 54814/1993, Japanese Laid-open Patent Publication 68789/1994, Japanese Laid-open Patent Publication 34941/1994, Japanese Laid-open Patent Publication 14519/1995 and the like).

(2) A compound layer made of tantalum (Ta), bismuth (Bi) which includes ethyl silicate or the like is formed on an electron beam irradiation side of abase body of a shadow mask (for example, Japanese Laid-open Patent Publication 182985/1995, Japanese Laid-open Patent Publication 182986/1995, Japanese Laid-open Patent Publication 254373/1994 or the like).

(3) A metal oxide layer in a sol state of an element having the atomic number of equal to or more than 40 is formed on an electron beam irradiation side of a base body of a shadow mask (Japanese Laid-open Patent Publication 40048/1999).

However, although the above-mentioned conventional means attempt to prevent the doming by suppressing the elevation of temperature of the shadow mask by making use of the reflection of electron beams, the X-ray irradiation is increased due to the irradiation of electron beams and hence, the electron beam reflection ability and the doming ability become contradictory to each other so that it is difficult to sufficiently ensure the rigidity of the shadow mask per se.

Further, since a layer is formed only on one side of the shadow mask, the thermal deformation prevention ability is determined by the thickness of the layer. When the thickness of the layer is increased so as to increase the electron beam reflection effect, the layer is pealed off or the difference in rigidity and thermal expansion coefficient between the front and back surfaces is increased. Further, when the thickness of the layer is decreased to reduce the peeling off, the thermal deformation prevention ability is reduced.

Further, when the thickness of the electron beam reflection layer is increased, the reflection of light on inner walls or the like of electron beam passing apertures of the shadow mask at the time of exposure of a phosphor screen using the shadow mask is increased thus giving rise to a new task including the difficulty in forming the phosphor screen of high definition.

### SUMMARY OF INVENTION

The present invention can provide a flat face type color cathode ray tube having a shadow mask which can realize the high definition by solving tasks derived from flattening of the shadow mask.

A typical constitution of the present invention lies in that a large number of micropores or micro irregularities are formed in a surface of a metal base body of a shadow mask provided to a color cathode ray tube and a surface film which infiltrates into these micropores or the micro irregularities substrate and covers the metal base body is provided.

### BRIEF DESCRIPTION OF THE DRAWINGS

FIG. 1 is a schematic cross-sectional view of an essential part of a shadow mask which constitutes a shadow mask structure for explaining a first embodiment of a color cathode ray tube of the present invention.

FIG. 2 is a schematic cross-sectional view of an essential part of a mounting portion between a mask frame and a shadow mask which constitute a shadow mask structure for explaining a second embodiment of the color cathode ray tube of the present invention.

FIG. 3 is a perspective view showing the whole constitution of the shadow mask structure of the color cathode ray tube of the present invention.

FIG. 4A, FIG. 4B, FIG. 4C, FIG. 5D, FIG. 5E and FIG. 5F are schematic step views for explaining one example of a method for manufacturing a shadow mask which constitutes the shadow mask structure used in the color cathode ray tube of the present invention, wherein FIG. 5D is the schematic step view which follows the schematic step view shown in FIG. 4C.

FIG. 6A is a schematic explanatory view of a conventional shadow mask, FIG. 6B is a schematic explanatory view of a flat face panel having a large inner-surface curvature, and FIG. 6C is a schematic explanatory view of an image which is actually observed on the face panel when the shadow mask is combined to the face panel.

FIG. 7A is a schematic explanatory view showing a shadow mask formed in a cylindrical shape, FIG. 7B is a schematic explanatory view of a flat face panel having an inner surface on which a curvature is given only in the horizontal direction, and FIG. 7C is a schematic explanatory view of an image actually observed on the face panel when the shadow mask is combined with the face panel.

FIG. 8A is a schematic explanatory view showing a shadow mask formed using a shadow mask material of the present embodiment, FIG. 8B is a schematic explanatory view of a flat face panel having a small inner-surface curvature, and FIG. 8C is a schematic explanatory view of an image which is actually observed on the face panel when the shadow mask is combined with the face panel.

FIG. 9 is a schematic cross-sectional view for explaining one example of the whole constitution of the color cathode ray tube of the present invention.

FIG. 10 is a schematic cross-sectional view for explaining another example of the whole constitution of the color cathode ray tube of the present invention.

### DESCRIPTION OF THE PREFERRED EMBODIMENTS

To describe typical constitutions among constitutions of the color cathode ray tube according to the present invention, they are as follows.

(1) The color cathode ray tube includes an evacuated envelope consisting of a panel having a phosphor of a plurality of colors applied to an inner surface thereof, a neck which houses an electron gun and a funnel which connects the panel and the neck, and a shadow mask structure which is arranged close to the phosphor applied to the inner surface of the panel and has a large number of electron beam passing apertures for color selection,

The shadow mask structure includes a shadow mask provided with a skirt portion on an outer periphery of an apertured region in which the electron beam passing apertures are formed and a mask frame formed of a metal frame which is mounted on the skirt portion, and the shadow mask has a metal base body having a large number of micropores or micro irregularities on a surface thereof and a surface film which is impregnated into the micropores or the micro irregularities and also covers the metal base body.

(2) In the constitution (1), the mask frame includes a metal frame body having a large number of micropores or micro irregularities on a surface thereof and a surface film which is impregnated into the micropores or the micro irregularities and covers the metal frame body.

(3) In the constitution (1) or (2), a major constitutional material of the surface film is ceramics.

(4) In the constitution (3), the surface film includes an oxide of any one of silicon, zirconium, titanium, indium and samarium or a mixture of these oxides as a main component.

(5) In the constitution (3), the surface film includes a nitride of any one of titanium, iron and chromium or a mixture of these nitrides as a major component.

(6) In the constitution (4) or (5), any one of silicon carbide, graphite and carbon or a mixture of these elements is mixed into the major component.

(7) In any one of the constitutions (1) to (6), the electron beam passing apertures for color selection formed in the shadow mask are arranged in a dot shape.

(8) In any one of the constitutions (1) to (6), the electron beam passing apertures for color selection formed in the shadow mask are arranged in a bead shape continuously extending in one direction.

(9) In any one of the constitutions (1) to (6), the electron beam passing apertures for color selection formed in the shadow mask are arranged in a slot shape having a major axis thereof extended in one direction.

In the above-mentioned respective constitutions, by arbitrarily changing the material and the thickness of the metal base body of the shadow mask, the material and the thickness of the metal frame body of the mask frame, the size in the planer direction/the depth in the thickness direction/the distribution of the micropores or the micro irregularities formed in these surfaces, the composition of the material and the film thickness of the impregnating surface film, it is possible to form the shadow mask structure having the proper strength, the proper thermal deformation resistance and the proper partial or whole doming compensation characteristics corresponding to the size of the shadow mask, the degree of curvature of the shadow mask, the grade of the electron beam passing apertures and the like.

In this manner, according to the above-mentioned typical constitutions of the present invention, the strength of the shadow mask structure can be enhanced and hence, the partial or whole doming due to thermal deformation can be compensated whereby a flat-face type color cathode ray tube having high definition can be obtained. Further, the rust prevention of the shadow mask or the mask frame or the surface treatment for suppressing the reflection of electron beams, that is, so-called blackening processing can be eliminated whereby the manufacturing steps can be simplified.

It is needless to say that the present invention is not limited to the above-mentioned respective constitutions and structures which will be explained in conjunction with embodiments hereinafter and various modifications are conceivable without departing from the technical concept of the present invention.

[Embodiments]

Embodiments of the present invention are explained in detail hereinafter in conjunction with drawings which describe these embodiments.

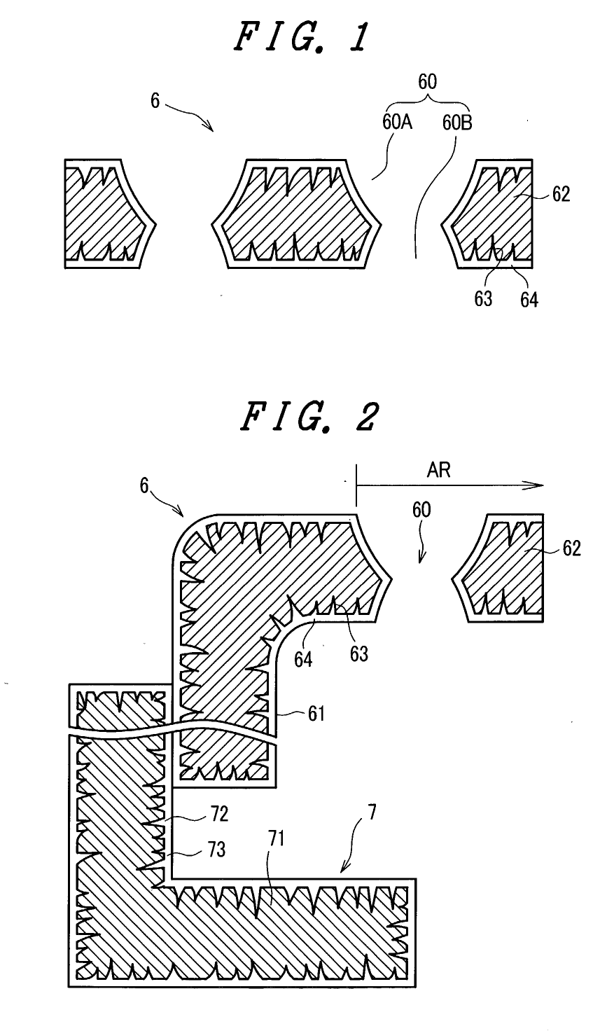

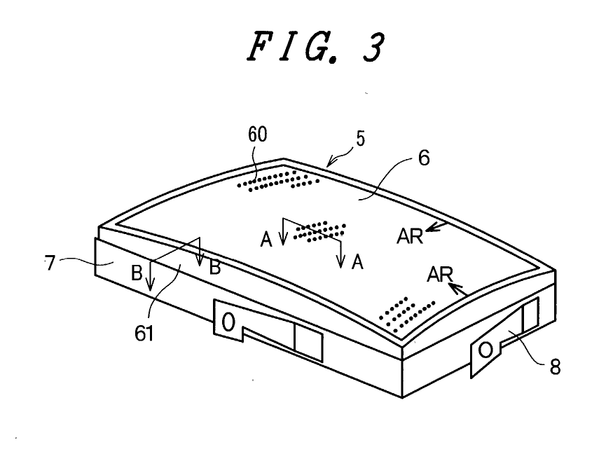

FIG. 1 is a schematic cross-sectional view of an essential part of a shadow mask which constitutes a shadow mask structure for explaining the first embodiment of a color cathode ray tube of the present invention, and FIG. 2 is a schematic cross-sectional view of an essential portion of a mounting portion between a mask frame and a shadow mask which constitute a shadow mask structure for explaining the second embodiment of the color cathode ray tube of the present invention.

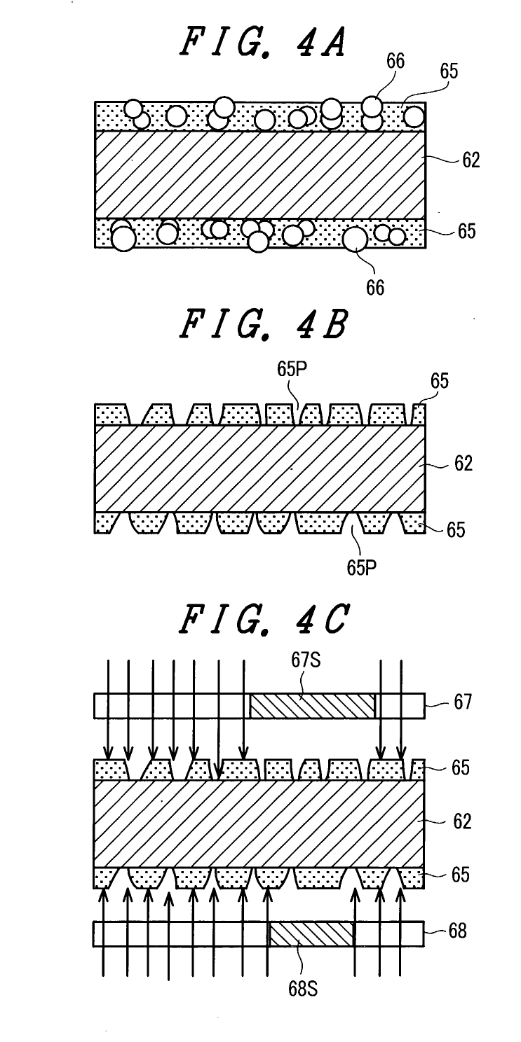

Further, FIG. 3 is a perspective view showing the whole constitution of the shadow mask structure of the color cathode ray tube of the present invention. Here, FIG. 1 is a cross-sectional view of an essential part of the shadow mask taken along a line A-A of FIG. 3 and FIG. 2 is also a cross-sectional view of essential parts of the shadow mask and the mask frame taken along a line B-B of FIG. 3.

As shown in FIG. 3, the shadow mask structure 5 includes a shadow mask 6 which is provided with a skirt portion 61 around an outer periphery of an apertured region AR where electron beam passing apertures 60 are formed and a mask frame 7 made of a metal frame body which is mounted on the skirt portion 61. Usually, the mask frame 7 has an L-shaped cross-section in the tube axis direction. The apertured region AR having a large number of electron beam passing apertures 60 which constitutes a main portion of the shadow mask 6 is formed in a curved surface corresponding to an inner-surface curvature of a face panel which will be explained later.

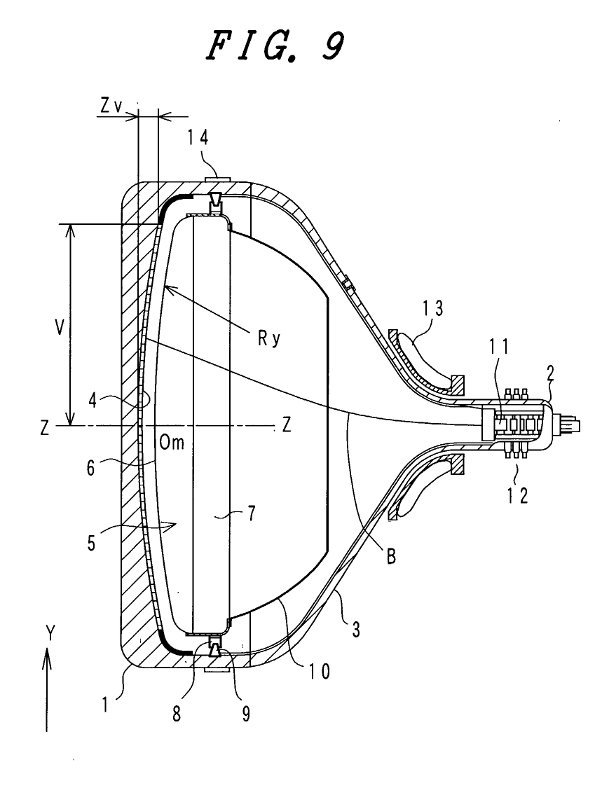

Then, the shadow mask structure 5 is constituted by fixing the skirt portion (peripheral portion) 61 which is formed by bending the periphery of the shadow mask 6 in the direction substantially parallel to the tube axis direction to the mask frame 7 by welding or the like. Here, suspension springs 8 are mounted on the mask frame 7 so as to mount the mask frame 7 to stud pins which are formed on an inner wall of the face panel in an erected manner (this constitution being explained later in conjunction with FIG. 9 and the like).

Reference numeral 62 in FIG. 1 indicates a shadow mask base body (metal base body) which constitutes the shadow mask 6. Here, the shadow mask base body 62 is formed of aluminum killed steel (abbreviated as “AK steel”). In front and back surfaces of the shadow mask base body 62, micropores or micro irregularities 63 having an opening diameter of approximately 0.01 μm to 0.5 μm and dug in the thickness direction of the shadow mask base body 62 are formed. The whole front and back surfaces including inner walls of the electron beam passing apertures 60 are covered with a surface film 64. Portions of the surface film 64 are impregnated into the micropores or the micro irregularities 63 thus constituting an integral structure with the shadow mask base body 62.

A large number of electron beam passing apertures 60 are formed in the apertured region AR. As shown in FIG. 1, the electron beam aperture 60 includes a large-diameter portion 60A which opens at a phosphor screen side and a small-diameter portion 60B which opens at an electron gun side, wherein a connection portion between the large-diameter portion 60A and the small-diameter portion 60B defines a diameter of the electron beam aperture.

Further, as shown in FIG. 2, micropores or micro irregularities 63 similar to those formed in the apertured region AR are also formed in the skirt portion 61 of the shadow mask 6 and the skirt portion 61 is covered with a surface film 64 such that the surface film 64 is impregnated into the micropores or the micro irregularities 63. Accordingly, the shadow mask 6 exhibits a sandwich structure consisting of the shadow mask base body 62 and the surface films 64 which are formed on both front and back surfaces of the shadow mask base body 62 thus largely enhancing the entire strength compared to a conventional shadow mask which is constituted of a single sheet.

In the same manner, with respect to the mask frame 7, micropores or micro irregularities 72 similar to the micropores or micro irregularities 63 are formed in a metal frame body 71 and the metal frame body 71 is covered with a surface film 73 such that the surface film 73 is impregnated into the micropores or the micro irregularities 72. Accordingly, the mask frame 7 also exhibits a sandwich structure consisting of the metal frame body 71 and the surface films 73 formed on the both front and back surfaces of the metal frame body 71 thus largely enhancing the entire strength compared to a conventional mask frame constituted of a single sheet.

Due to such a constitution of this embodiment, the thermal deformation (partial or whole doming of the shadow mask) derived from the irradiation of the electron beams can be suppressed so that a flat-face type color cathode ray tube having high definition can be obtained. Here, the partial doming is a phenomenon in which, as in the case of a window display, for example, due to the local irradiation of electron beams, a portion of the shadow mask 6 which corresponds to such an irradiation is more subjected to the thermal expansion than other portions and hence, the portion is curved in a dome shape. On the other hand, the whole doming is a phenomenon in which the whole shadow mask is curved in a dome shape due to the irradiation of electron beams to the whole surface.

In the above-mentioned embodiment, in both of the shadow mask 6 and the mask frame 7 which constitute the shadow mask structure 5, the micropores or micro irregularities 63, 72 and the surface films 64, 73 are formed. However, the above-mentioned micropores or micro irregularities 63 and the surface film 64 may be formed only in the base body 62 of the shadow mask 6 and the mask frame 7 may be constituted of a conventional mask frame.

Subsequently, an example of a method for manufacturing the shadow mask structure 5 used in the color cathode ray tube of the present invention is explained. Here, the manufacture of the shadow mask 6 which constitutes the shadow mask structure 5 is explained as an example.

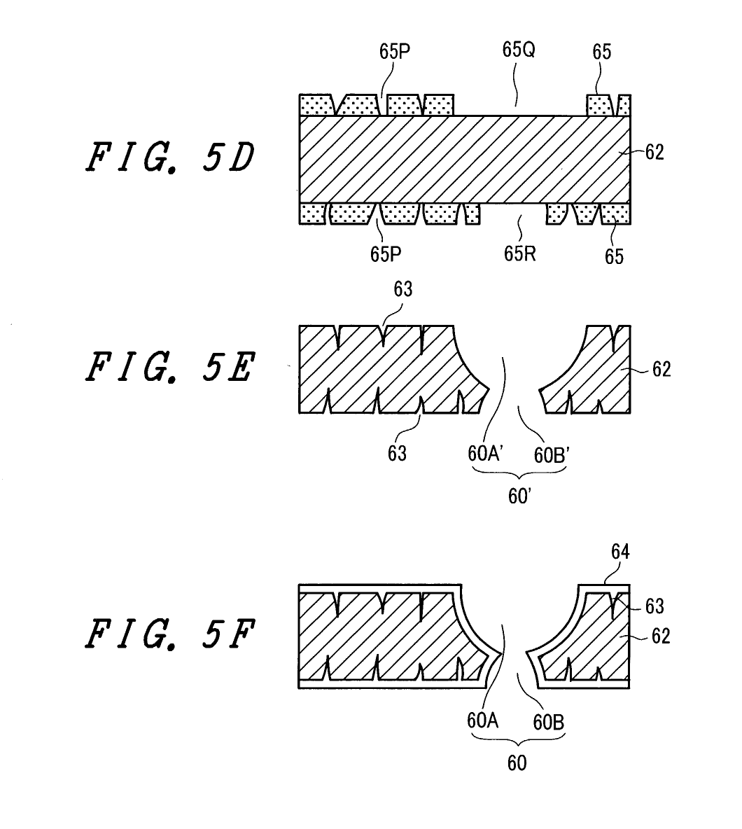

FIG. 4A, FIG. 4B, FIG. 4C, FIG. 5D, FIG. 5E and FIG. 5F are schematic step views for explaining an example of a method for manufacturing the shadow mask 6 which constitutes the shadow mask structure 5 used in a color cathode ray tube of the present invention, wherein FIG. 5D is the schematic step view following the schematic step view shown in FIG. 4C.

First of all, solid naphthalene which is hardly dissolved in water and has high vapor pressure is dispersed in a photo resist for forming electron beam passing apertures 60 in the shadow mask 6 as minute particles of 0.01 to 0.2 μm. As a major component of the photo resist, polyvinyl alcohol and ammonium dichromate are used, wherein the concentration of the solid naphthalene with respect to a solid amount of the photo resist is set to 30%.

This naphthalene-dispersed photoresist is applied to both surfaces of a shadow mask base body 62 (a sheet body before press forming) in a usual manner and is dried. As a result, as shown in FIG. 4A, photo resist films 65 in which naphthalene minute particles 66 are mixed are formed on surfaces of the shadow mask base body 62. A film thickness of the photo resist films 65 is approximately 1.0 μm.

The shadow mask base body 62 having the photo resist films 65 is heated up to 150 degree centigrade so as to evaporate naphthalene. Due to the evaporation of naphthalene, open pores 65P of 0.01 to 0.5 μm are formed in the film of photo resist 65 (FIG. 4B).

Subsequently, as shown in FIG. 4C, the front surface side (phosphor screen side) and the back surface side (electron gun side) of the shadow mask 6 respectively undergo the exposure through exposure masks 67, 68 for forming electron beam passing apertures. The front-surface side exposure mask 67 includes light shielding portions 67S corresponding to large-diameter aperture portions 60A of the electron beam passing apertures 60 and the back-surface side exposure mask 68 includes light shielding portions 68S corresponding to small-diameter portions 60B of the electron beam passing apertures 60.

After performing the exposure, the photo resist at the non-exposure portions is removed so as to provide a state shown in FIG. 5D in which the photo resist 65 having the open pores 65P and openings 65Q and 65R for electron beam passing apertures is applied to the shadow mask base body 62. By making such a structure undergo an etching treatment, it is possible to obtain the shadow mask base body 62 which includes the micropores or the micro irregularities 63 and apertures 60′ having apertures 60A′ and apertures 60B′ shown in cross section in FIG. 5E. Here, apertures 60′ correspond to the electron beam passing apertures 60, the apertures 60A′ correspond to the large-diameter portions 60A and apertures 60B′ correspond to the small-diameter portions 60B.

The size in the planer direction of the micropores or micro irregularities 63 is approximately 0.01 to 0.5 μm corresponding to the size of the open pores 65P, the depth in the thickness direction of the micropores 63 is controlled based on the etching treatment time such that the micropores 63 are approximately present in the vicinity of the planer surface. The degree of the depth of the micropores 63 is determined based on given shadow mask characteristics such as the material and thickness of the shadow mask base body 62, the screen corresponding size and the like. Further, since the open pores 65P have the smaller diameter compared to openings 65Q, 65R for electron beam passing apertures 60, the progress of etching is slow and hence, the depth in the thickness direction is limited.

The shadow mask base body 62 in which the micropores 63 and the apertures 60′ corresponding to the electron beam aperture 60 are formed is immersed in a liquid having the composition shown in Table 1 for 10 to 20 seconds. Then, the shadow mask base body 62 is heated for 10 minutes at a temperature of 150 degree centigrade after drying. Accordingly, as shown in FIG. 5F, it is possible to obtain a ceramics impregnated shadow mask in which the surface film 64 covers front and back surfaces of the shadow mask base body 62 such that the surface film 64 is impregnated into the micropores 63. The thickness of the surface film 64 is set to approximately 0.4 μm.

TABLE 1

| | | concentration |
|---|---|---|
| composition 1 | | (wt %) |
| ethoxy silane | | 1.0 |
| nitric acid | | 0.002 |
| zirconium oxide | (average particle size 70 nm) | 0.2 |
| graphite | (average particle size 80 nm) | 0.1 |
| dodecyl benzenesulfonic | | 0.001 |
| acid soda | | |
| tin-doped indium oxide | (average particle size 30 nm) | 0.2 |
| ethyl alcohol | | 60 |
| deionized water | | balance |

In Table 1, etoxy silane enhances the rigidity of the shadow mask and, at the same time, suppresses the thermal expansion coefficient of the shadow mask 6. Zirconium oxide exhibits the favorable heat dissipation property and also enhances the rigidity of the shadow mask 6. Further, the tin-doped indium oxide is used as an additive for providing conductivity to the shadow mask.

The shadow mask 6 manufactured in this manner exhibits a sandwich structure in which the shadow mask base body 62 and the surface films 64 are integrally formed so that the strength of the shadow mask 6 is enhanced as a whole. As mentioned previously, the depth of the micropores 63 formed in the shadow mask base body 62 influences the strength of the whole shadow mask 6 and hence, the depth is disposed in the vicinity of the surface of the shadow mask base body 62 and is limited to a depth which is determined in view of the entire strength of the shadow mask 6.

A plate body of the shadow mask 6 manufactured in this manner is subjected to the annealing treatment in a usual manner, is subjected to press forming and, thereafter, is welded to the mask frame 7. Thereafter, the suspension springs 8 are mounted on side walls of the mask frame 7 thus completing the shadow mask structure 5.

According to the present invention, the conventional blackening treatment is unnecessary for manufacturing of the shadow mask 6. Accordingly, the blackening step becomes unnecessary, and at the same time, the deformation of the shadow mask 6 in the blackening step in which the treatment temperature is elevated to 600 to 700 degree centigrade can be obviated.

In this manner, according to this embodiment, the strength of the whole shadow mask 6 can be largely enhanced compared to the conventional shadow mask which is constituted of a single plate, and the partial or the whole doming derived from the thermal deformation can be compensated so that the flat face type color cathode ray tube having high definition can be obtained. Further, it is possible to eliminate the surface treatment for rust prevention of the shadow mask 6 and the mask frame 7 or for suppressing the electron beam reflection, that is, a so-called blackening treatment so that the manufacturing step can be simplified.

Table 2 is a table which shows the composition for forming the surface film 64 of the shadow mask 6 used in another embodiment of the color cathode ray tube of the present invention. The shadow mask base body 62 shown in FIG. 5E is immersed in a liquid having such a composition. This embodiment can also obtain advantageous effects similar to those obtained by the above-mentioned embodiment.

TABLE 2

| | | concentration |
|---|---|---|
| composition 2 | | (wt %) |
| ethoxy silane | | 1.1 |
| nitric acid | | 0.002 |
| butoxy zirconium | | 0.3 |
| silicon carbide | (average particle size 70 nm) | 0.1 |
| dodecyl benzenesulfonic | | 0.0012 |
| acid soda | | |
| tin-doped indium oxide | | 0.2 |
| ethyl alcohol | | 60 |
| deionized water | | balance |

Table 3 is a table which shows the composition for forming the surface film 64 of the shadow mask 6 used in still another embodiment of the color cathode ray tube of the present invention. The shadow mask base body 62 shown in FIG. 5E is immersed in a liquid having such a composition. This embodiment can also obtain advantageous effects similar to those obtained by the above-mentioned embodiments.

TABLE 3

| | | concentration |
|---|---|---|
| composition 3 | | (wt %) |
| ethoxy silane | | 1.1 |
| nitric acid | | 0.002 |
| TiN | (average particle size 90 nm) | 0.1 |
| carbon black | (average particle size 80 nm) | 0.1 |
| dodecyl benzenesulfonic | | 0.0012 |
| acid soda | | |
| titanium oxide | (average particle size 60 nm) | 0.05 |
| tin oxide | (average particle size 20 nm) | 0.2 |
| ethyl alcohol | | 60 |
| deionized water | | balance |

To improve the affinity with oxide or the like, 0.01 to 0.1% by weight of γ-glycidooxy propyltrimethoxy silane (silane coupling agent) may be added.

Although solid naphthalene is used as material which is hardly dissolved in water and has high vapor pressure in the above-mentioned embodiments, anthraquinone, salicyclic acid, hydroquinone and other substance in a solid form which exhibits high vapor pressure and is easily evaporated may be used in place of the solid naphthalene.

Further, although the aluminum killed steel is used as the material of the shadow mask base body 63 in the above-mentioned embodiments, any material which can be used as the material of shadow mask 6 such as Invar material, U-Invar material and the like can obtain the same advantageous effects. Further, it is needless to say that the present invention is applicable to a clad material which is formed by laminating them in a layered structure.

Several characteristics of the shadow masks 6 (ceramics impregnated shadow mask) according to respective embodiments are shown in Table 4 in comparison with those of the conventional shadow mask (shadow mask formed by using usual AK steel). The characteristics of the flat-face type color cathode ray tube using such shadow masks are shown in Table 5. In Table 5, BU indicates the uniformity of brightness.

TABLE 4

| | | thermal | heat | |
|---|---|---|---|---|
| | | expansion | radiation | Young's |
| sample name | hardness | coefficient | rate | modulus |
| usual AK steel | 100 | 100 | 100 | 100 |
| composition in Table 1 | 140 | 95 | 100 | 125 |
| composition in Table 2 | 150 | 85 | 100 | 125 |
| composition in Table 3 | 125 | 88 | 100 | 120 |

TABLE 5

| | feeling of | | mask fall | inner surface |
|---|---|---|---|---|
| composition | flatness | BU | strength | filter |
| composition of Table 1 | B | A | A | unnecessary |
| composition in Table 2 | B | A | A | unnecessary |
| composition in Table 3 | B | A | A | unnecessary |
| usual AK steel | C | C | C | necessary |

As shown in FIG. 4, it is understood that according to the shadow mask 6 of the embodiments, the thermal expansion coefficient can be reduced compared to the usual shadow mask and the hardness and the Young's modulus are largely enhanced. FIG. 4 shows data which are obtained by forming surface films which exhibit a volume fraction of 30% of micropores or micro irregularities and a film thickness of 0.4 μm on both front and back surfaces of the shadow mask base body. A, B and C in Table 5 respectively express grades of evaluation (excellent, favorable, allowable). However, the characteristics may be further enhanced by increasing the volume fraction of the micropores or micro irregularities up to approximately 60%.

According to an experiment, it is possible to increase the radius of curvature of the shadow mask 6 by approximately 20% without spoiling the fall strength by increasing the volume fraction of the micropores or the micro irregularities 63 up to the above-mentioned level. It is also possible to decrease the panel peripheral thickness of the flat-face type color cathode ray tube with a size of a screen of a shadow mask type being set to 51 cm in the diagonal direction by 20%.

As a result, the large cost reduction is realized and the feeling of flatness can be enhanced. Further, since the radius of curvature of the inner surface of the panel can be increased, the reflection on the inner surface becomes less apparent compared to a case in which a currently available shadow mask is used and hence, a filter for preventing reflection on an inner surface can be made unnecessary. Then, the spring back of the shadow mask 6 after forming the skirt portion 61 using a press can be reduced so that the quality of welding the shadow mask 6 to the mask frame 7 can be enhanced.

Although the above-mentioned embodiments have been explained exclusively with respect to the shadow mask 6 which constitutes the shadow mask structure 5, it is possible to make the mask frame 7 undergo the similar treatment. As shown in FIG. 2, by forming the surface films 73 on the front and back surfaces of the mask frame 7 such that portions of the surface films 73 are partially impregnated into the micropores 72 in the same manner as the shadow mask 6, the rigidity (strength) of the mask frame 7 can be enhanced.

Along with the enhancement of the rigidity of the mask frame 7, the fall strength of the cathode ray tube, the durability and the deformation of the mask frame 7 during respective heat treatment steps can be suppressed. Further, due to the enhancement of the tolerance for purity, the more favorable white uniformity can be obtained. Still further, by mixing metal having a large atomic number or a compound thereof into the liquid shown in Table 1 to Table 3, the reflectance of electron beams is enhanced so that the temperature elevation of the shadow mask 6 is prevented whereby the doming prevention effect is further enhanced.

According to the present invention, it is possible to perform the design of the color cathode ray tube which can realize the flattening of regions which have been impossible to be flattened with the prior art from a viewpoint of strength of the shadow mask. Hereinafter, the display characteristics of the color cathode ray tube using various flat masks are explained.

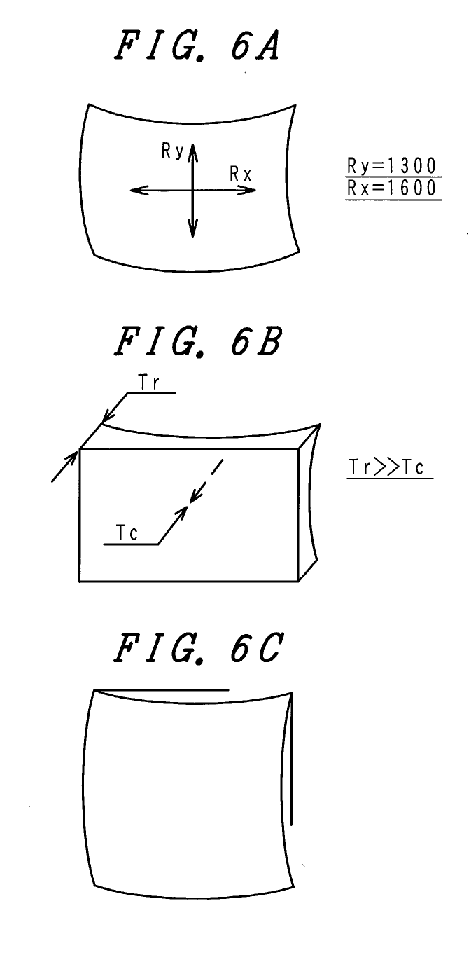

FIG. 6A, FIG. 6B and FIG. 6C are schematic explanatory views of images actually observed on the face panel when the shadow masks of the present invention and the comparison examples are combined to the flat-face panel having the large inner-surface curvature. FIG. 6A is the schematic explanatory view of the conventional shadow mask, FIG. 6B is the schematic explanatory view of the flat-face panel having the large inner-surface curvature, and FIG. 6C is the schematic explanatory view of the image actually observed on the face panel when the shadow mask is combined to the face panel.

To show an example of specific numerical values, they are as follows. FIG. 6A shows an apertured region of the shadow mask which is formed by a press into a shape having an average radius of curvature Rx in the horizontal (along a long axis) direction of 1600 mm and an average radius of curvature Ry in the vertical (along a short axis) direction of 1300 mm. FIG. 6B shows an effective screen region of the face panel having an approximately flat outer surface and an inner surface of the large curvature. With respect to this effective screen region, a thickness Tr of a corner portion in the tube axis direction is set considerably larger than a thickness Tc of a center portion in the tube axis direction (Tr>>Tc).

In this case, assume a wall thickness difference (Tr−Tc) between at the corner (an end in the diagonal direction) and at the center of the panel effective screen as a diagonal wedge amount Wr, the ratio Wr/Tc between the wedge amount Wr and the wall thickness Tc at the center of the face panel is set to not less than 1.2. With respect to the shadow mask formed by a press, as shown in FIG. 6C, the shadow mask appears such that the screen is recessed more as a position on the shadow mask is shifted from the center of the panel to the periphery of the panel. Then, with respect to the viewing direction, the center of the screen is bulged so that an image with a little flat feeling is observed.

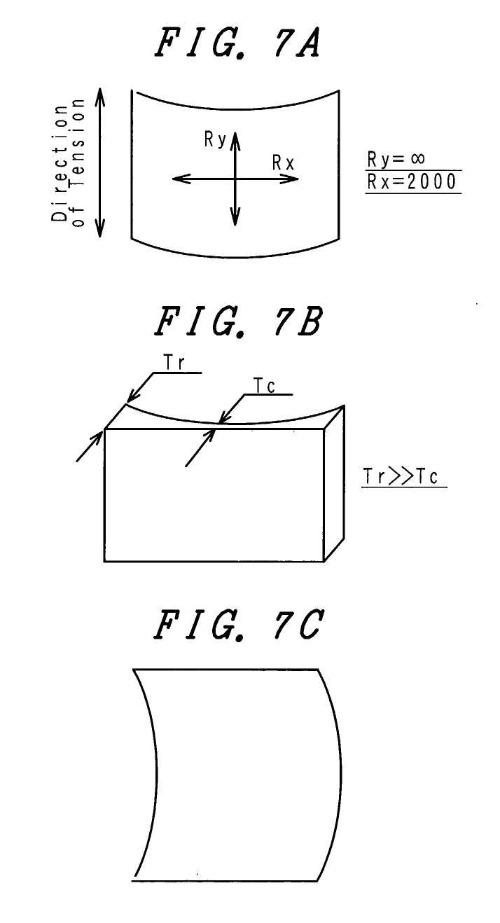

FIG. 7A, FIG. 7B and FIG. 7C are schematic explanatory views of an image of the shadow mask which is actually observed on the face panel when the shadow mask formed in a cylindrical surface shape is assembled to the flat face panel to which the curvature is given only in the horizontal direction. That is, FIG. 7A is a schematic explanatory view of a shadow mask formed in a cylindrical surface shape, FIG. 7B is a schematic explanatory view of the flat face panel having a curvature only in the horizontal direction on the inner surface thereof, and FIG. 7C is a schematic explanatory view of the image of the shadow mask which is actually observed on the face panel when the shadow mask is assembled to the face panel.

To show an example of specific numerical values, they are as follows. FIG. 7A shows an apertured region of the shadow mask (a so-called bead-line-like color selection electrode) which is formed into a shape having an average radius of curvature Rx in the horizontal (along a long axis) direction of 2000 mm and a radius of curvature Ry in the vertical (along a short axis) direction of an infinite value (∞). FIG. 7B shows an effective screen region of the face panel having an approximately flat outer surface and an inner surface which has a curvature only in the horizontal direction. With respect to this effective screen region, a thickness Tr of a corner portion in the tube axis direction is set considerably larger than a thickness Tc of a center portion in the tube axis direction (Tr>>Tc). In this case, the ratio Wr/Tc between the wedge amount Wr in the diagonal direction and the wall thickness Tc at the center of the face panel is set to not less than 1.0.

The shadow mask formed in the cylindrical surface shape constitutes a so-called tension mask to which tension is applied in the vertical direction as shown in FIG. 7A. It is difficult to make the shadow mask have a curvature in the tension applying direction. Accordingly, the inner surface of the face panel also has an approximately infinite radius of curvature with respect to the tension applying direction of the shadow mask. That is, the inner surface of the face panel is substantially linear in the vertical direction. Accordingly, due to the refraction of the glass material which constitutes the face panel, the center portion of the face panel is observed such that it is curved in a concave shape in the vertical direction as shown in FIG. 7C.

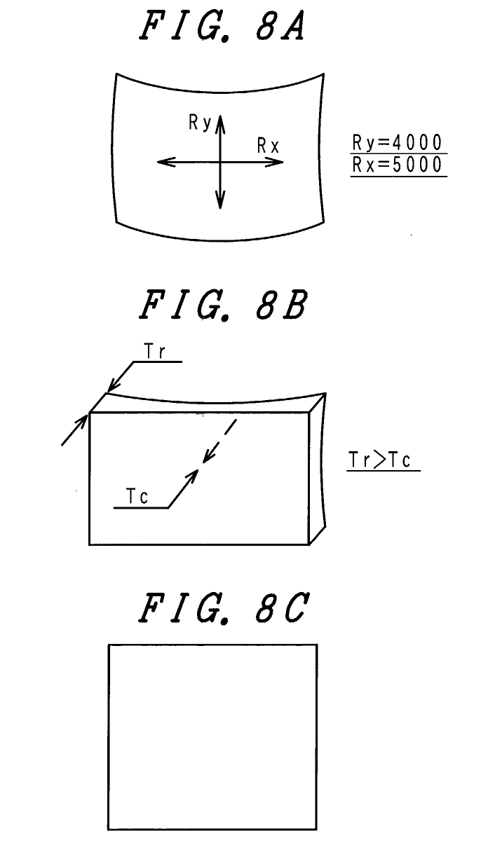

FIG. 8A, FIG. 8B and FIG. 8C are schematic explanatory views of an image of the shadow mask formed of the shadow mask material of this embodiment of the present invention which is actually observed on the face panel when the shadow mask is assembled to the flat face panel having an inner surface with a small curvature. That is, FIG. 8A is a schematic explanatory view of the shadow mask which is formed of the shadow mask material of this embodiment, FIG. 8B is a schematic explanatory view of the flat face panel having the inner surface with the small curvature and FIG. 8C is a schematic explanatory view of the image of the shadow mask which is actually observed on the face panel when the shadow mask is assembled to the face panel.

To show an example of specific numerical values, they are as follows. FIG. 8A shows an apertured region of the shadow mask which is formed by a press into a shape having an average radius of curvature Rx in the horizontal direction (along a long axis) of 5000 mm and an average radius of curvature Ry in the vertical direction (along a short axis) of 4000 mm. FIG. 8B shows an effective screen region of the face panel having an approximately flat outer surface and an inner surface with a curvature which is smaller than the curvature shown in FIG. 6B. With respect to this effective screen region, a thickness Tr of a corner portion in the tube axis direction is set slightly larger than a thickness Tc of a center portion in the tube axis direction (Tr>Tc).

With the provision of the constitution of this embodiment, the design of a cathode ray tube which satisfies conditions which make the shadow mask appear optically flat can be realized. That is, the shadow mask of this embodiment exhibits the large physical strength and hence, the shadow mask per se has a doming attenuation function. Accordingly, with the use of a press, it becomes possible to form the shadow mask into a shape which is substantially flat, wherein an average radius of curvature Rx in the horizontal direction (along the long axis) and an average radius of curvature Ry in the vertical direction (along a short axis) are respectively set to not less than 3000 mm.

Accordingly, the difference (a corner wedge amount Wr) between a thickness Tr of a corner portion and a thickness Tc of a center portion of the face panel shown in FIG. 8B can be decreased so that an optical distance LrTr of the thickness Tr of the corner portion and an optical distance LcTc of the thickness Tc of the center portion become substantially equal. Accordingly, an image to be observed also becomes substantially flat as shown in FIG. 8C. In this case, the ratio Wr/Tc between the corner wedge amount Wr and the wall thickness Tc of the center portion of the panel is set to not more than 0.8.

Further, since the thickness of the peripheral portion of the face panel can be decreased, the image can easily obtain the high brightness so that the uniformity of the brightness over the whole screen can be enhanced. Further, when the shadow mask material of this embodiment is applied to the tension mask shown in FIG. 7A, the curved surface can be formed such that the radius of curvature in the horizontal direction is increased and hence, the radius of curvature of the inner surface of the face panel in the horizontal direction can be also increased. Accordingly, in the same manner as the constitution shown in FIG. 8B, the thickness of the peripheral portion of the face panel can be decreased so that the brightness characteristics of the display screen can be enhanced.

Further, with respect to the tension mask shown in FIG. 7A, since the color selection apertures are formed like bead lines continuously extending in one direction, there may be a case that bead-line-like grids which connect bead-line-like color selection apertures vibrate due to an impact or the like. Accordingly, to prevent this vibration, a thin wire is mounted on the outside of the curved surface of the tension mask along the long axis (X axis). However, by applying the ceramics impregnated shadow mask material of this embodiment to the tension mask, since the material strength of the ceramics impregnated shadow mask material is considerably strong compared to the conventional Invar material, it is unnecessary to mount the wire for preventing the vibration particularity.

As has been described above, it is possible to make the press mask become substantially flat so that a suitable design can be carried out by making the inner surface of the face panel also substantially flat. Accordingly, it is possible to reduce the reflection light from the inner surface of the panel caused by the difference of wall thickness between the center portion and the peripheral portion of the panel shown in FIG. 6B without requiring reflection prevention means such as an inner surface filter film or the like. Further, since the peripheral portion of the face panel can be made thin by making the inner surface of the panel become substantially flat, the panel can be made light-weighted and the manufacturing cost of the color cathode ray tube can be reduced.

Further, also with respect to the color cathode ray tube using the so-called tension mask to which the tension is applied in one direction (generally in the vertical direction), the radius of curvature of the inner surface in the direction (generally in the horizontal direction) perpendicular to one direction of the face panel to which the present invention is applied can be increased and hence, the wall thickness of the peripheral portion of the panel can be made thin whereby the reflection light from the inner surface of the panel can be suppressed, the panel can be made light-weighted, and the manufacturing cost of the color cathode ray tube can be reduced.

Further, by setting the average radius of curvature Ry of the pressed mask of this embodiment shown in FIG. 8A along the short axis (Y axis) to not less than 10000 mm, in place of the tension mask, the pressed mask of this embodiment can be applied to the face panel which has the inner surface thereof shown in FIG. 7B formed in a cylindrical surface shape and increases the radius of curvature of the inner surface thereof in the long axis (X axis) direction.

Further, the shadow mask of this embodiment is formed of the ceramics impregnated plate. This enables the design which can also suitably correct the partial doming of the curved surface of the mask, for example, the local thermal deformation due to the window pattern display by adjusting the physical characteristics of one surface side and the other surface side of the shadow mask in such a manner that amounts of evaporating material mixed into resists on one surface side and the other surface side of the shadow mask are adjusted so as to change the size and the distribution of the micropores.

The conventional shadow mask structure has performed the correction of the doming of a curved surface of a mask caused by the impingement of electron beams and the thermal expansion of a mask frame caused by the elevation of the ambient temperature by using suspension springs mounted on the mask frame. In this embodiment, since the mask frame also adopts the ceramics impregnated structure, it is possible to suppress the thermal deformation of the mask frame per se.

Accordingly, it is possible to make the suspension springs have the simple structure by obviating the complicated designing of the suspension springs so that the tolerance for design of the whole shadow mask structure can be enhanced. As a result, it is possible to provide a color cathode ray tube having high brightness and high definition which is operable also in the high current region in which the doming correction has been impossible conventionally.

FIG. 9 is a schematic cross-sectional view for explaining one example of the whole constitution of the color cathode ray tube of the present invention. This color cathode ray tube includes an evacuated envelope which is comprised of a panel (face panel) 1 which coats phosphor of a plural colors on an inner surface thereof, a neck 2 which houses an electron gun 11 and a funnel 3 having an approximately funnel shape which connects the panel 1 and the neck 2.

The phosphor 4 of three colors is applied to the inner surface of the panel 1 and the shadow mask 6 which has a large number of color selection apertures is installed close to the phosphor 4. Numeral 5 indicates the shadow mask structure. The shadow mask 6 which constitutes the shadow mask structure 5 includes the above-mentioned ceramics impregnated shadow mask and is fixedly secured to the mask frame 7 to which the similar treatment is applied or a conventional mask frame 7 by welding.

The shadow mask 6 is curved with large radii of curvature in the horizontal direction as well as in the vertical direction. Assume an axis which is perpendicular to a short axis (Y axis: an arrow Y direction in the drawing) of an approximately rectangular apertured region of the shadow mask 6 and passes the center Om of the apertured region as the Z axis (the tube axis) and a falling amount in the Z axis direction from the center Om of the apertured region at an arbitrary point (x, y) in the apertured region of the shadow mask 6 as Zm, a curved shape of the shadow mask 6 can be generally defined by a following equation.

Zm=A1x²+A2X⁴+A3y²+A4y⁴+A5x²y²+A6x²y⁴+A7x⁴y²+A8x⁴y⁴ (A1 to A8: coefficients)

Then, a desired curved shape can be obtained by determining the coefficients A1 to A8 in the equation. Although the above-mentioned curved shape is defined by taking the shadow mask 6 as an example, the curved shape of the effective screen region of the panel 1 may be defined in the same manner.

The curved surface expressed by the above-mentioned definition equation is an aspherical shape in many cases and hence, the radii of curvature thereof are different depending on arbitrary positions of the curved surface. Accordingly, the curvature (radius of curvature) of the shadow mask can be defined by a following equation by assuming such a curvature as an average radius of curvature described in FIG. 8A.

Ry=(Zv²+V²)/2Zv

wherein Ry indicates an average radius of curvature (mm) along the short axis (Y axis) of the apertured region, V indicates a distance (mm) in the direction perpendicular to the Z axis from the center Om of the apertured region to the end portion along the Y axis, and Zv indicates a fall amount (mm) in the Z axis direction between the center Om of the apertured region and the end portion along theY axis. Although the above-mentioned average radius of curvature is defined along the short axis (Y axis) of the apertured region of the shadow mask as an example, the average radius of curvature can be defined along the long axis (X axis) or along the diagonal line in the same manner. Further, the average radius of curvature can be defined in the same manner with respect to the effective screen region of the panel 1.

A magnetic shield 10 is fixedly secured to an electron-gun-side of the mask frame 7, while the mask frame 7 is suspended and held by stud pins 9 which are mounted in a protruding manner on an inner wall of a skirt portion of the panel 1 by way of the suspension springs 8. A deflection yoke 13 is exteriorly mounted on a neck side of the funnel 3 and deflects three electron beams B irradiated from the electron gun 11 in the horizontal direction as well as in the vertical direction (an arrow Y direction in the drawing) so as to form an image on the phosphor screen 4. In the drawing, numeral 12 indicates a magnetic correction device for purity correction, convergence correction or the like, and numeral 14 indicates an implosion prevention band.

With the provision of the color cathode ray tube having such a constitution, the color image display of high brightness and high definition which can suppress the color slurring caused by doming of the curved surface of the shadow mask can be obtained.

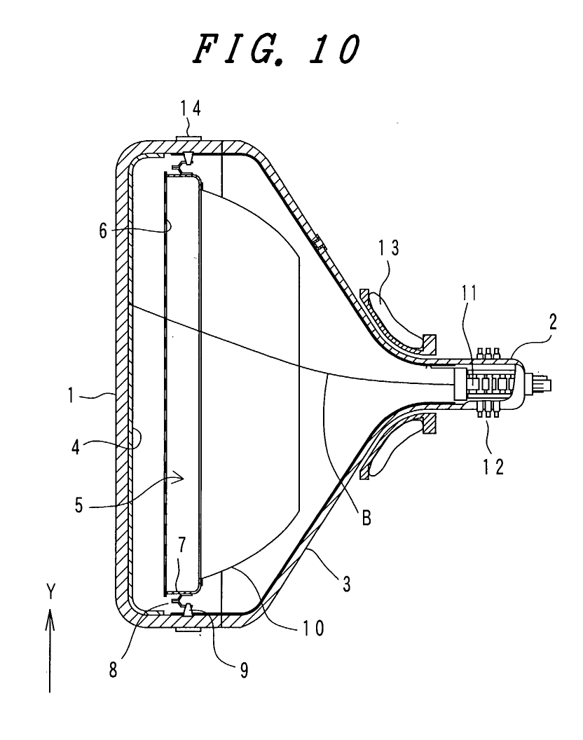

FIG. 10 is a schematic cross-sectional view for explaining another embodiment of the whole constitution of a color cathode ray tube of the present invention. In the drawing, numerals which are equal to the numerals used in FIG. 9 correspond to identical functional parts. This color cathode ray tube includes an evacuated envelope which is comprised of a panel 1 having an inner surface to which phosphor of a plurality of colors is applied, a neck 2 housing an electron gun 11 and an approximately funnel-shaped funnel 3 which connects the panel 1 and the neck 2. However, in this embodiment, the inner surface of the panel 1 has a large radius of curvature in the horizontal direction and an infinite radius of curvature in the vertical direction (an arrow Y direction in the drawing).

The shadow mask 6 which constitutes a color selection electrode installed in the color cathode ray tube has a large radius of curvature in the horizontal direction and has a radius of curvature in the vertical direction which is considerably larger than the radius of curvature in the horizontal direction or is infinite. The shadow mask 6 is fixedly secured to the mask frame 7 while being applied with tension. However, the shadow mask 6 may be fixedly secured to the mask frame 7 in the state that the shadow mask 6 holds a shape thereof by itself without being applied with tension.

Even when the shadow mask 6 is fixedly secured to the mask frame 7 in the state that the shadow mask 6 holds the shape thereof by itself without being applied with tension, the partial thermal deformation and doming can be corrected by the thermal deformation compensation function of the shadow mask and the color slurring or the like can be reduced whereby the color image display of high brightness and high definition can be obtained.

As has been explained heretofore, according to the typical constitutions of the present invention, by adopting the ceramics containing shadows mask as the shadow mask which constitutes the color selection electrode, the blackening treatment is unnecessary compared to the prior art which uses the single sheet made of Invar material. Accordingly, the manufacturing steps can be simplified. Further, the strength of the shadow mask can be largely increased and hence, the occurrence of the partial thermal deformation and the doming can be reduced whereby it is possible to provide the color cathode ray tube of high brightness and high definition while ensuring the thin face panel.

What is claimed is:

1. A color cathode ray tube comprising an evacuated envelope which includes a panel having a phosphor of a plurality of colors applied to an inner surface thereof, a neck which houses an electron gun and a funnel which connects the panel and the neck, and a shadow mask structure which is arranged close to the phosphor applied to the inner surface of the panel and has a large number of electron beam passing apertures for color selection, wherein
the shadow mask structure includes a shadow mask provided with a skirt portion on an outer periphery of an apertured region in which the electron beam passing apertures are formed and a mask frame formed of a metal frame which is mounted on the skirt portion, and
the shadow mask has a metal base body having a large number of micropores or micro irregularities on a surface thereof and a surface film which is impregnated into the micropores or the micro irregularities and also covers the metal base body.

2. A color cathode ray tube according to claim 1, wherein a major constitutional material of the surface film is ceramics.

3. A color cathode ray tube according to claim 2, wherein the surface film includes an oxide of any one of silicon, zirconium, titanium, indium and samarium or a mixture of these oxides as a main component.

4. A color cathode ray tube according to claim 2, wherein the surface film includes a nitride of any one of titanium, iron and chromium or a mixture of these nitrides as a major component.

5. A color cathode ray tube according to claim 3, wherein any one of silicon carbide, graphite and carbon or a mixture of these elements is mixed into the major component.

6. A color cathode ray tube according to claim 4, wherein any one of silicon carbide, graphite and carbon or a mixture of these elements is mixed into the major component.

7. A color cathode ray tube comprising an evacuated envelope which includes a panel having a phosphor of a plurality of colors applied to an inner surface thereof, a neck which houses an electron gun and a funnel which connects the panel and the neck, and a shadow mask structure which is arranged close to the phosphor applied to the inner surface of the panel and has a large number of electron beam passing apertures for color selection, wherein
the shadow mask structure includes a shadow mask provided with a skirt portion on an outer periphery of an apertured region in which the electron beam passing apertures are formed and a mask frame formed of a metal frame which is mounted on the skirt portion, and
the mask frame has a metal frame body having a large number of micropores or micro irregularities on a surface thereof and a surface film which is impregnated into the micropores or the micro irregularities and also covers the metal frame body.

8. A color cathode ray tube according to claim 7, wherein a major constitutional material of the surface film is ceramics.
